(19) United States
(12) Patent Application Publication
(10) Pub. No.: US 2015/0133207 A1
(43) Pub. Date: May 14, 2015

(54) ITEM USAGE SERVICE PROVIDING METHOD AND SERVER

(71) Applicants: Woon Yong Kim, Suwon-si (KR); In Seok Lee, Seoul (KR)

(72) Inventors: Woon Yong Kim, Suwon-si (KR); In Seok Lee, Seoul (KR)

(73) Assignee: INTELLECTUAL DISCOVERY CO., LTD., Seoul (KR)

(21) Appl. No.: 14/363,752

(22) PCT Filed: Mar. 30, 2012
(86) PCT No.: PCT/KR2012/002371

§ 371 Date: Jan. 9, 2015

(30) Foreign Application Priority Data
Dec. 9, 2011 (KR) 10-2011-0132300

(51) Int. Cl. G07F 17/32

(52) U.S. Cl. CPC G07F 17/329; G07F 17/3253
USPC 463/17

(57) ABSTRACT

The present invention relates to a technique of outputting a win result message of a certain item to a game screen of all users when the certain item is won during usage of a lottery item that may be used by a selection input and one of a plurality of items may be won during the usage in an online or an offline game. A method for providing an item usage service includes receiving usage input from a user terminal for a lottery item that is capable of being used in a game and in which any one among at least one predetermined item is won in the usage through a server providing an item usage service; selecting and providing one of a first win item having a predetermined win probability and a second win item having a higher win probability than the first win item according to the win probability when receiving the usage input; and generating a win result message for the first win item win when the selected win item is the first win item to be displayed at a game screen of all users connected to the game.

### TECHNICAL FIELD

The present invention relates to a technique of outputting a win result message of a certain item to a game screen of all users when the certain item is won during usage of a lottery item that may be used by a selection input and one of a plurality of items may be won during the usage in an online or an offline game.

### BACKGROUND ART

With the development of communications networks, various online game services have been being provided. Further, as graphics techniques and the performance of user terminals are improved, high-quality game programs are being created. Game contents which provide detailed descriptions for real or visual space have also been being developed.

Accordingly, the user utilization of online games is increased, and the game genres are diversified. Recently, various online games such as sports games, role playing games, and first person shooting games have been most popular.

As one feature of the online games, users can enjoy their favorite online games with each other by simultaneously accessing the same game contents system. The users can individually enjoy the games through cooperation or competition with different users by controlling their characters or the like on the same game screen.

Moreover, in the online games, the users can accomplish one mission by cooperation with different users, or can enjoy game contents by competition with different users. In this case, in the online games, it is necessary to provide contents that rouse a competitive spirit between the users. This is because it is required to have the users continuously access and play the online games by rousing the competitive spirit between the users in order to maintain or increase the user utilization of the online games in terms of their features.

The contents for rousing the competitive spirit between the users may be roughly divided into a level of a user character, an item that can be applied to the user character, a skill implemented by a user, and the like. Particularly, the level and the skill of the user character may be improved by the user while the user plays the game and increases an experience level of the user character.

Accordingly, a beginner should use items for improving the ability of his/her character to equally compete with skilled users having a higher experience level in the online games. As a result, services such as item design, item image, item sales, and the like have recently become hot issues in the online games.

On the other hand, among the items, there are items that are selected according to the effect thereof. Also, for a certain item having a very low win probability among the items, a management necessity of increasing a game use rate of the user winning the certain item occurs.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention relates to a technique for increasing a usage rate of an item usage service for users by outputting a win result message of a certain item to a game screen of all of users when the certain item having a low win probability is won by randomly winning one among a plurality of predetermined items in usage of a lottery item in which one of a plurality of items may be won during the usage.

### Technical Solution

A method for providing an item usage service according to an exemplary embodiment of the present invention includes: receiving usage input from a user terminal for a lottery item that is capable of being used in a game and in which any one among at least one predetermined item is won in the usage through a server providing an item usage service; selecting and providing one of a first win item having a predetermined win probability and a second win item having a higher win probability than the first win item according to the win probability when receiving the usage input; and generating a win result message for the first win item win when the selected win item is the first win item to be displayed at a game screen of all users connected to the game.

In the present invention, the generated win result message includes identification information of the user, a kind of the lottery item, and a kind of the first win item.

In the present invention, a number of the second win items that are won for each user when using the lottery item at a predetermined interval is limited.

In the present invention, in the selecting and providing, when a number of any one item among the second win items that are pre-provided to the user is the limited number, one of the first win item and the second win item except for the second win item pre-provided to the user until the limited number is selected and provided according to the win probability.

A server providing an item usage service according to an exemplary embodiment of the present invention includes: an item usage input receiver receiving a usage input from a user terminal for a lottery item that is capable of being used in a game and in which any one among at least one predetermined item is won in the usage; an item provider selecting and providing one of a first win item having a predetermined win probability and a second win item having a higher win probability than the first win item according to the win probability when receiving the usage input; and a controller generating a win result message for the first win item win to be displayed at a game screen of all users connected to the game when the selected win item is the first win item.

In the present invention, the item provider selects and provides one of the first win item and the second win item except for the second win item pre-provided to the user until the limited number according to the win probability when a number of any one item among the second win items that are pre-provided to the user is the limited number.

In the present invention, the controller generates the win result message including identification information of the user, a kind of the lottery item, and a kind of the first win item.

In the present invention, the controller limits a number of the second win item that is won for each user when using the lottery item at a predetermined interval.

A recording medium recorded with a program to realize a method for providing an item usage service according to an exemplary embodiment of the present invention includes: receiving a usage input from a user terminal for a lottery item that is capable of being used in a game and in which any one among at least one predetermined item is won in the usage through a server providing an item usage service; selecting and providing one of information of a first win item having a predetermined win probability and a second win item having a higher win probability than the first win item when receiving the usage input; and generating a win result message for the first win item win when the selected win item is the first win item to be displayed at a game screen of all users connected to the game.

### Advantageous Effects

According to the present invention, by outputting the win result message of the certain item at the game screen of all users when winning the certain item having a low win probability, utilization of the item usage service of the users may be increased.

### DESCRIPTION OF THE DRAWINGS

FIG. 1 is a flowchart of an operation of a method for providing an item usage service according to an exemplary embodiment of the present invention.

FIG. 2 is a flowchart of an operation of a method for limiting a lottery item usage according to an exemplary embodiment of the present invention.

FIG. 3 is a diagram of an item usage service providing server according to an exemplary embodiment of the present invention.

FIG. 4 to FIG. 6 are examples of an item usage service usage screen according to each exemplary embodiment of the present invention.

### MODE FOR INVENTION

A method for providing an item usage service according to an exemplary embodiment of the present invention includes: receiving usage input from a user terminal for a lottery item that is capable of being used in a game and in which any one among at least one predetermined item is won in the usage through a server providing an item usage service; selecting and providing one of a first win item having a predetermined win probability and a second win item having a higher win probability than the first win item according to the win probability when receiving the usage input; and generating a win result message for the first win item win when the selected win item is the first win item to be displayed at a game screen of all users connected to the game.

In the present invention, the generated win result message includes identification information of the user, a kind of the lottery item, and a kind of the first win item.

In the present invention, a number of the second win items that are won for each user when using the lottery item at a predetermined interval is limited.

In the present invention, in the selecting and providing, when a number of any one item among the second win items that are pre-provided to the user is the limited number, one of the first win item and the second win item except for the second win item pre-provided to the user until the limited number is selected and provided according to the win probability.

A server providing an item usage service according to an exemplary embodiment of the present invention includes: an item usage input receiver receiving a usage input from a user terminal for a lottery item that is capable of being used in a game and in which any one among at least one predetermined item is won in the usage; an item provider selecting and providing one of a first win item having a predetermined win probability and a second win item having a higher win probability than the first win item according to the win probability when receiving the usage input; and a controller generating a win result message for the first win item win to be displayed at a game screen of all users connected to the game when the selected win item is the first win item.

In the present invention, the item provider selects and provides one of the first win item and the second win item except for the second win item pre-provided to the user until the limited number according to the win probability when a number of any one item among the second win items that are pre-provided to the user is the limited number.

In the present invention, the controller generates the win result message including identification information of the user, a kind of the lottery item, and a kind of the first win item.

In the present invention, the controller limits a number of the second win item that is won for each user when using the lottery item at a predetermined interval.

A recording medium recorded with a program to realize a method for providing an item usage service according to an exemplary embodiment of the present invention includes: receiving a usage input from a user terminal for a lottery item that is capable of being used in a game and in which any one among at least one predetermined item is won in the usage through a server providing an item usage service; selecting and providing one of information of a first win item having a predetermined win probability and a second win item having a higher win probability than the first win item when receiving the usage input; and generating a win result message for the first win item win when the selected win item is the first win item to be displayed at a game screen of all users connected to the game.

### MODE FOR INVENTION

Hereinafter, an item usage service providing method and a server according to an exemplary embodiment of the present invention will be described with reference to accompanying drawings.

It is obvious that the following exemplary embodiment is a detailed description which is provided for better understanding of the present invention and does not limit the scope of the present invention. Therefore, an equivalent invention which performs the same function as the present invention may also be covered by the scope of the present invention.

In adding reference numerals to components of each drawing, even though the same components are illustrated in different drawings, it is to be noted that these components are denoted by the same reference numerals if possible. In describing exemplary embodiments of the present invention, well-known functions or constructions will not be described in detail since they may unnecessarily obscure the understanding of the present invention.

In addition, in describing components of the present specification, terms such as first, second, A, B, (a), and (b) may be used. These terms are used only to differentiate the components from other components, but the nature, sequence, order, etc., of the corresponding components are not limited by these terms. When a component is “connected”, “coupled”, or “linked” to another component, it is to be noted that the component may be directly connected or linked to the another component, but the component may be “connected”, “coupled”, or “linked” to the another component via another component therebetween.

In an exemplary embodiment of the present invention, “communication”, “communication network”, and “network” may be used to have the same meaning. The three terminologies indicate a wired or wireless local area and wide area data transmitting/receiving network through which a file is transmitted/received between a user terminal, another user terminal, and a download server.

In the following description, “game server” indicates a server computer to which users access to use game contents. In the case of a game which has a small capacity or a small number of users, a plurality of game programs may be operated by one game server. Further, in the case of a game which has a large capacity or a large number of real time accessing members, one or more game servers which operate one game may be provided depending on a function of the game.

In addition, middleware for databases or servers which perform payment processing may be connected to the game server, but the description thereof will be omitted in the present invention.

Herein, an online game indicates game contents that can be used by users who access the aforementioned game server. Particularly, the online game indicates a game that can be simultaneously accessed and enjoyed by a plurality of users and increase levels of the users by, e.g., acquiring experience levels while rearing characters through playing of the game in the game. The online game also indicates a game that can be used to buy various kinds of items in the game to play the game more smoothly.

Herein, an item indicates all data that can give assistance to playing the game and can be generally understood as an item in the game. For example, in a role-playing game, an item for further increasing an experience level obtained when a character of a user subdues a monster, an item for changing the appearance of the character, and the like may correspond to the items in the present invention.

In addition, in a sports game, a card item for using a character, an item for increasing a capability level of the character, an item for recovering a condition of the character, an item for increasing a capability level in the game and simultaneously for changing the appearance of the character by mounting the card to the character, and the like pertain to the items in the present invention. As such, all items that can be used by a character during the play of a game or can be used by a user to apply it to the game pertain to the items in the present invention.

For the items, the duration of use effect may be permanent or limited. In this case, the same kinds of items having different durations are the same items in the present invention. For example, an item “A” for increasing a capability level for one week and an item “A” for increasing a capability level for two weeks may be recognized as the same items although they may be different items from a viewpoint of a database.

In the present invention, a lottery item means an item such as one kind of lottery to provide at least one item to a user when using the item. The users may purchase the lottery item in an item shop, and may use the lottery item in an inventory screen capable of confirming the item possessed by the user.

As an example of a sports game, the user may obtain a player character required for a sports game through the lottery item. If the lottery item is used, according to the lottery item in which a predetermined range (e.g., an ability value range) is determined, the lottery item may be an item capable of randomly obtaining one player character among the player characters included in the predetermined range. The kind of the lottery item may be divided according to different predetermined ranges such as an ability value range.

Accordingly, the user may obtain any one item including the player character required when performing the game by using the lottery item. Also, the lottery items may be used one by one, and may include a plurality of lottery items of the same kind.

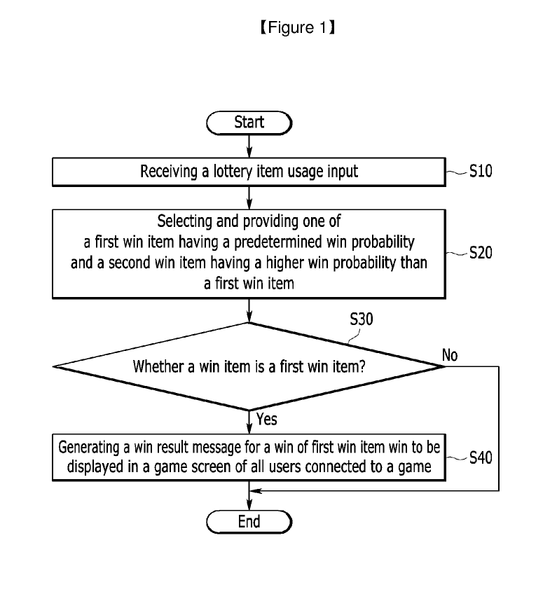

FIG. 1 is a flowchart of an operation of a method for providing an item usage service according to an exemplary embodiment of the present invention.

Referring to FIG. 1, the method for providing the item usage service according to an exemplary embodiment of the present invention performs a step S10 of receiving a usage input of the described lottery item from a user terminal by a server for providing an item usage service.

The item usage service providing server may transmit an item usage menu as a menu that can be a usage input for any one among at least one lottery item to the user terminal by the user through the user terminal in the item shop or a game access screen.

Accordingly, the user may confirm their lottery item and simultaneously may perform the input for using it through the item screen of the terminal, and particularly is capable of confirming the lottery item of the user.

The item usage menu may be displayed for each region where the item is displayed for the corresponding item to be used, and one item usage menu is output at a portion of the region that may confirm the item of the user such that the user may use the item through a selection input for the above item usage menu where the item is selected.

If the step S10 is performed, the server performs a step S20 of selecting and providing one of a first win item having a predetermined win probability and a second win item having a higher win probability than the first win item.

Here, the first win item is an item having a very low win probability by the setting of the server and the second win item is an item having a higher win probability than the first win item by the setting of the server, and a number of the second win items is much larger than a number of the first win items, for example, the number of second win items may be much larger than the number of the first win item by a ratio of about 10:1. Accordingly, the win probability is also higher in the second win item than in the first win item.

To provide a dramatic effect to the user, when a win item list is displayed, while the lottery item is used one by one to a predetermined number, an animation of a type that the won item is filled one by one to the win item line may be realized. Accordingly, by confirming that the won items are filled with the list every predetermined time unit (e.g., 1 second), the user may feel a thrill in the lottery item usage. However, a method of displaying the won item is not limited thereto.

The item included in the win item list transmitted to the user terminal is registered in an item storage space held by the described user, and the user may use the won item.

After the step S20, the server performs a step S30 of determining whether the selected win item is the first win item or the second win item, and when the selected win item is the first win item, the server performs a step S40 of generating the win result message for the win of the first win item and outputting it to the game screen of all users that are connected to the game.

Since the first win item has the remarkably low win probability, if the first win item is won, the server generates the message including identification information of the user, a kind of the lottery item, and detailed information of the obtained first win item, and outputs it to the game screen of all users that are connected to the game. Accordingly, morale of the user winning the first win item is increased, and game connection utilization is increased along with other users' hopes of winning the first win item.

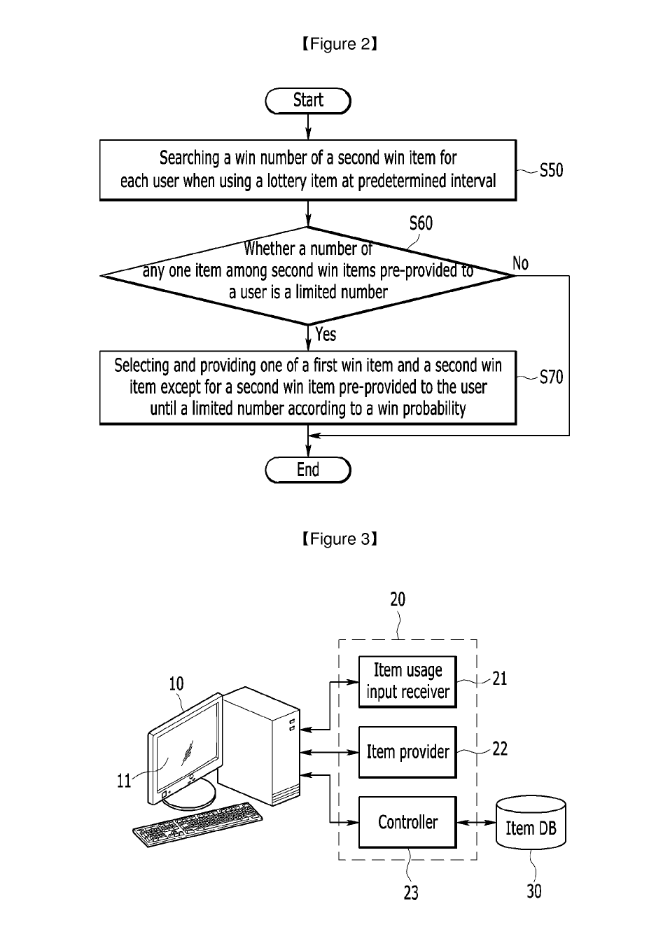

FIG. 2 is a flowchart of an operation of a method of limiting a lottery item usage according to an exemplary embodiment of the present invention.

Referring to FIG. 2, the server performs a step S50 of searching a win number of the second win item for each user when using the lottery item at predetermined intervals.

As a search result of the win number of the second win item, the server performs a step S60 of determining whether a number of any one item among the second win items pre-provided to the user is a limited number.

When the number of any one item among the second win items pre-provided to the user is a limited number, the server performs a step S70 of selecting and providing one of the first win item and the second win item except for the second win item pre-provided to the user until the limited number according to the win probability.

Since the second win item has the higher win probability than the first win item, although the plurality of lottery items are used, there is a case that only the second win item is won, and when the second win item is won by using the lottery item by the user, the interest in the game may be deteriorated. Therefore, the server may respectively limit the number of second win items that are won for each user by the predetermined cycle when using the lottery item.

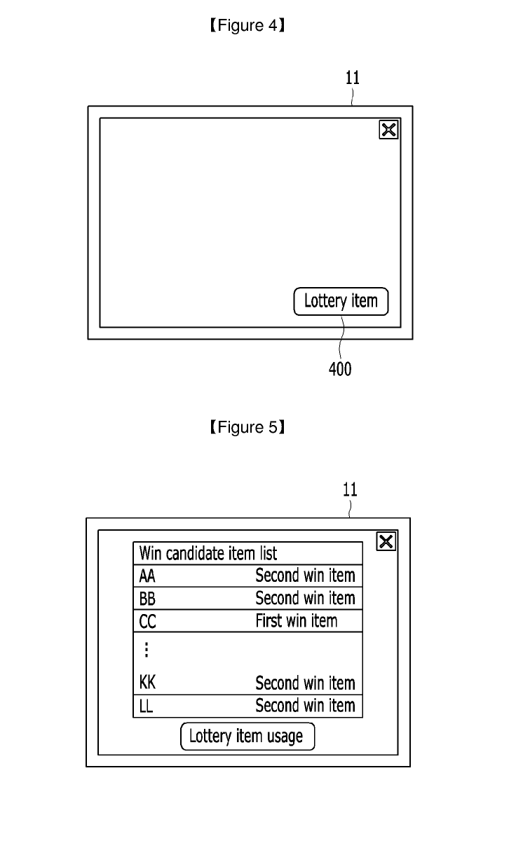

FIG. 3 is a diagram of an item usage service providing server according to an exemplary embodiment of the present invention.

In FIG. 3, the item usage service providing server 20 according to an exemplary embodiment of the present invention is respectively connected to a user terminal 10 and an item data base 30. The item data base 30 stores information for the item storage space allocated to each user along with the information for the items to be provided and to be used in the game.

The item usage service providing server 20 includes an item usage input receiver 21, an item provider 22, and a controller 23.

The item usage input receiver 21 performs a function of receiving usage input for the lottery item from the user terminal 10. That is, the input of the user terminal 10 for the item usage menu is sensed.

The item provider 22 selects and provides one of information of the first win item having the predetermined win probability and the second win item having the higher win probability than the first win item when receiving the usage input for the lottery item.

Here, the first win item is the item having the remarkably low win probability by the setting of the server, the second win item is the item having the higher win probability than the first win item by the setting of the server, and the number of the second win items is much larger than the number of the first win items in a win candidate item menu displayed in the user terminal, and for example, the number of the second win items is much larger than the number of the first win items by a ratio of about 10:1. Accordingly, the win ratio of the second win item becomes higher than that of the first win item.

When the number of any one item among the second win items pre-provided to the user is the limited number, the item provider 22 may select and provide one of the first win item and the second win item except for the second win item pre-provided to the user until the limited number according to the win probability.

When the selected win item is the first win item, the controller 23 generates the win result message for the first win item win to be displayed to the game screen of all users connected to the game. The controller 23 may generate the win result message including the identification information of the user, the kind of the lottery item, and the kind of the first win item to output it to the terminal of all users that are connected to the game, and may respectively limit the number of the won second win items for each user when using the lottery item at the predetermined cycle.

Since the second win item has the higher win probability than the first win item, although the plurality of lottery items are used, there is a case that only the second win item is won. Therefore, the controller 23 may respectively limit the number of the won second win items for each user when using the lottery item at the predetermined intervals.

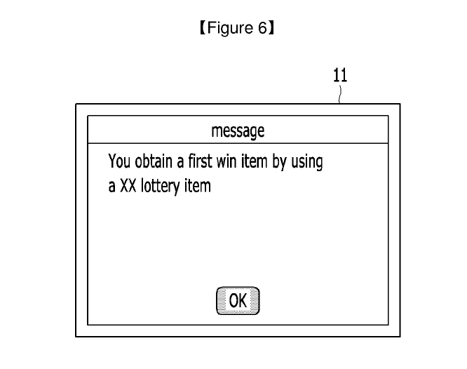

FIG. 4 to FIG. 6 show examples of an item usage service usage screen according to each exemplary embodiment of the present invention.

Referring to FIG. 4, in the user terminal 10, a lottery item menu 400 which is one of the information for the item possessed by the user may be output to the screen 11 of the user terminal.

If the selection input of the lottery item menu 400 shown in FIG. 4 is received, as shown in FIG. 5, the list of items to be won is included in the screen 11 of the user terminal, and in this case, the first win item having the predetermined win probability and the second win item having the higher win probability than the first win item are displayed in the list of items to be won. In the list of items to be won, the number of the second win items is much larger than the number of the first win items such that the win probability is higher in the second win items than the first win items.

FIG. 6 shows a message displayed on the screen 11 of the user terminal if the first win item is won, after an OK button of the lottery item usage is input.

The method for providing the item usage service in accordance with the exemplary embodiments of the present invention as described above may be executed by the applications basically installed in the terminal (including programs included in a platform, an operating system, or the like which are basically installed in the terminal), and may also be executed by the applications (i.e., programs) which are directly installed in the terminal by the user via an application store server or an application store server such as a web server associated with the applications or the corresponding services. In this respect, the method for providing the item usage service in accordance with the exemplary embodiments of the present invention may be implemented by the applications (i.e., programs) which are basically installed or directly installed by the user in the terminal, and may be recorded in a computer readable recording medium of the terminal and the like.

The programs are recorded in the computer readable recording medium and are executed by the computer, such that the above-mentioned functions may be executed.

As described above, in order for the computer to execute the method for providing the item usage service according to each exemplary embodiment of the present invention, the above-mentioned programs may include codes which are coded with computer languages such as C, C++, JAVA, machine language, and the like which may be read by a processor (CPU) of the computer.

The code may include a function code associated with a function of defining the above-mentioned functions, and may also include an execution procedure related control code required for the processor of the computer to execute the above-mentioned functions according to a predetermined procedure.

Further, the code may further include a memory reference related code indicating at which location (address number) of the memory inside or outside the computer additional information or media required for the processor of the computer to execute the above-mentioned functions need to be referenced.

Further, in order for the processor of the computer to execute the above-mentioned functions, when the processor needs to communicate with any other computers or servers, etc. at a remote location, the code may further include a communication-related code about how the processor of the computer communicates with any other computers or servers at a remote location or which information or media the processor of the computer transmits and receives at the time of the communication, by using the communication module (for example, wired and/or wireless communication module) of the computer.

Further, a functional program for implementing the present invention, a code and a code segment associated therewith, and the like may be easily inferred or changed by programmers in the art to which the present invention pertains in consideration of a system environment of the computer which reads the recording medium and executes the program.

Hereinabove, examples of a computer readable recording medium recorded with programs as described above include a ROM, a RAM, a CD-ROM, a magnetic tape, a floppy disk, an optical media storage device, and the like.

Further, a computer readable recording medium recorded with programs as described above may be distributed to a computer system connected through a network, and thus store and execute a computer readable code by a distributed manner. In this case, at least one computer among a plurality of distributed computers may execute a part of the above-mentioned functions and transmit the executed results to at least one of the other distributed computers, and the computer receiving the result may also execute a part of the above-mentioned functions and provide the executed results to the other distributed computers.

In particular, a computer readable recording medium recorded with applications, which are programs for executing the method for providing the item usage service in the game according to the exemplary embodiment of the present invention, may be a storage medium (for example, a hard disk, and the like) included in an application store server or an application providing server such as a web server associated with applications or corresponding services, and the like, or the application providing server itself.

A computer, which may read a recording medium recorded with applications that are programs for executing the method for providing the item usage serves according to the exemplary embodiment of the present invention, may include not only a general PC such as a typical desktop and a laptop but also a mobile terminal such as a smart phone, a tablet PC, personal digital assistants (PDAs), and a mobile communication terminal, and is to be construed as all computable devices.

When a computer, which may read a recording medium recorded with applications that are programs for executing the method for providing the item usage service according to the exemplary embodiment of the present invention, is a mobile terminal such as a smart phone, a tablet PC, a personal digital assistant (PDA), and a mobile communication terminal, the applications are downloaded from an application providing server to a general PC and thus may also be installed in the mobile terminal through a synchronization program.

Hereinabove, although it has been mentioned that all components configuring the exemplary embodiment of the present invention described hereinabove are combined with each other as one component or are combined and operated with each other as one component, the present invention is not necessarily limited to the above-mentioned exemplary embodiment. That is, all the components may also be selectively combined and operated with each other as one or more component without departing from the scope of the present invention. In addition, although each of all the components may be implemented by one independent piece of hardware, some or all of the respective components which are selectively combined with each other may be implemented by a computer program having a program module performing some or all of functions combined with each other in one or multiple pieces of hardware. The codes and the code segments configuring the computer program may be easily inferred by a person having ordinary skill in the art to which the present invention pertains. The computer programs are stored in the computer readable media and are read and executed by the computer and may implement the exemplary embodiment of the present invention. As the storage medium of the computer programs, a magnetic recording medium, an optical recording medium, and the like may be used.

Further, it will be further understood that the terms “comprises” or “have” used in this specification may include the corresponding components unless explicitly described to the contrary and therefore, do not preclude other components but further include the components. In addition, unless defined otherwise in the detailed description, all the terms including technical and scientific terms have the same meaning as those generally understood by those skilled in the art to which the present invention pertains. Generally used terms such as those defined in a dictionary should be interpreted as having the same meanings as those within a context of the related art, and should not be interpreted as ideally or excessively formal meanings unless clearly defined in the present specification.

The spirit of the present invention has been exemplified. It will be appreciated by those skilled in the art that various modifications and alterations can be made without departing from the essential characteristics of the present invention. Accordingly, the exemplary embodiments disclosed in the present invention do not limit but describe the spirit of the present invention, and the scope of the present invention is not limited by the exemplary embodiments. The scope of the present invention should be interpreted by the following claims, and it should be interpreted that all spirits equivalent to the following claims fall within the scope of the present invention.

1. A method for providing an item usage service, comprising:
receiving usage input from a user terminal for a lottery item that is capable of being used in a game and in which any one among at least one predetermined item is won in the usage through a server providing an item usage service;
selecting and providing one of a first win item having a predetermined win probability and a second win item having a higher win probability than the first win item according to the win probability when receiving the usage input; and
generating a win result message for the first win item win when the selected win item is the first win item to be displayed at a game screen of all users connected to the game.

2. The method of claim 1, wherein
the generated win result message includes identification information of the user, a kind of the lottery item, and a kind of the first win item.

3. The method of claim 1, wherein
a number of the second win items that are won for each user when using the lottery item at a predetermined interval is limited.

4. The method of claim 1, wherein,
in the selecting and providing,
when a number of any one item among the second win items that are pre-provided to the user is the limited number, one of the first win item and the second win item except for the second win item pre-provided to the user until the limited number is selected and provided according to the win probability.

5. A server providing an item usage service, comprising:
an item usage input receiver receiving a usage input from a user terminal for a lottery item that is capable of being used in a game and in which any one among at least one predetermined item is won in the usage;
an item provider selecting and providing one of a first win item having a predetermined win probability when receiving the usage input and a second win item having a higher win probability than the first win item according to the win probability; and
a controller generating a win result message for the first win item win to be displayed at a game screen of all users connected to the game when the selected win item is the first win item.

6. The server of claim 5, wherein
the item provider selects and provides one of the first win item and the second win item except for the second win item pre-provided to the user until the limited number according to the win probability when a number of any one item among the second win items that are pre-provided to the user is the limited number.

7. The server of claim 5, wherein
the controller generates the win result message including identification information of the user, a kind of the lottery item, and a kind of the first win item.

8. The server of claim 7, wherein
the controller limits a number of the second win items that are won for each user when using the lottery item at a predetermined interval.

9. A computer readable recording medium recorded with a program to realize a method for providing an item usage service, the method comprising:
receiving usage input from a user terminal for a lottery item that is capable of being used in a game and in which any one among at least one predetermined item is won in the usage through a server providing an item usage service;
selecting and providing one of a first win item having a predetermined win probability and a second win item having a higher win probability than the first win item when receiving the usage input; and
generating a win result message for the first win item win when the selected win item is the first win item to be displayed at a game screen of all users connected to the game.
